(19) United States
(12) Patent Application Publication
(10) Pub. No.: US 2026/0360788 A1
(43) Pub. Date: Nov. 12, 2026

(54) ELECTROCHEMICAL DEVICE

(71) Applicant: SAMSUNG ELECTRO-MECHANICS CO., LTD., Suwon-si (KR)

(72) Inventors: Si Ho KIM, Suwon-si (KR); Jung Deok PARK, Suwon-si (KR); Dong Jin KIM, Suwon-si (KR); Sung Han KIM, Suwon-si (KR); Sang Hak YOON, Suwon-si (KR); Sun Ju HWANG, Suwon-si (KR)

(73) Assignee: SAMSUNG ELECTRO-MECHANICS CO., LTD., Suwon-si (KR)

(21) Appl. No.: 19/535,694

(22) Filed: Feb. 10, 2026

(30) Foreign Application Priority Data
May 8, 2025 (KR) 10-2025-0059959

(51) Int. Cl. H01M 8/248; C25B 9/70

(52) U.S. Cl. CPC H01M 8/248; C25B 9/70

(57) ABSTRACT

An electrochemical device includes first and second end plates stacked in a first direction and a stack region disposed between the first and second end plates. The stack region includes at least one electrochemical cell. A pressurizing portion is disposed outside the first end plate and includes a spring wound around an axis extending in a direction different from the first direction. A connection portion connects the spring to the second end plate. An outer end of the spring is movable in the first direction as the spring is wound around or released from the axis, thereby applying a pressurizing force to the stack region. The configuration enables stable application of load to the stack region during operation of the electrochemical device.

### CROSS-REFERENCE TO RELATED APPLICATIONS

This application claims the benefit of priority to Korean Patent Application No. 10-2025-0059959 filed on May 8, 2025 in the Korean Intellectual Property Office, the disclosure of which is incorporated herein by reference in its entirety.

### TECHNICAL FIELD

The present disclosure relates to an electrochemical device.

An electrochemical device includes a fuel cell generating electrical energy by electrochemically reacting fuel (e.g., hydrogen) and an oxidizer (e.g., oxygen), an electrolytic cell generating hydrogen and oxygen through the electrolysis of water, and the like.

As examples of such an electrochemical device, a solid oxide fuel cell (SOFC) and a solid oxide electrolysis cell (SOEC) include a cell comprised of an air electrode, a fuel electrode, and a solid electrolyte having oxygen ion conductivity, and the cell may be referred to as a solid oxide cell. A solid oxide cell produces electrical energy through an electrochemical reaction or produces hydrogen by electrolyzing water in a reverse reaction of the solid oxide fuel cell. In addition thereto, other types of fuel cells or electrolytic cells, such as a phosphoric acid fuel cell (PAFC), an alkaline fuel cell (AFC), a polymer electrolyte membrane fuel cell (PEMFC), and a direct methanol fuel cell (DMFC), are also used as a type of electrochemical device.

In the case of an electrochemical device, the electrochemical device is commonly used as a stack structure in which unit cells are disposed between a pair of separators, where the separators may electrically connect the cells in series. In the stack structure of the electrochemical cell, it is necessary to stack a plurality of cells and fasten the same, and to this end, methods such as bonding each component together using an adhesive or fastening by pressurizing an end plate with a certain pressure, are used. Representative methods for pressurizing the end plate include a bolt fastening method and a spring fastening method. In this type of fastening method, there is a problem in that a load changes significantly depending on a change in stack thickness, making it difficult to maintain a stable pressing force.

### SUMMARY

An aspect of the present disclosure is to implement an electrochemical device having a pressurizing portion for applying a stable load to a stack structure of an electrochemical cell.

According to an embodiment of the present disclosure, an electrochemical device may include first and second end plates stacked in a first direction, a stack region disposed between the first and second end plates, the stack region including at least one electrochemical cell, a pressurizing portion disposed on the outside of the first end plate, and including a spring wound around an axis in a direction, different from the first direction, and a connection portion connected to the spring and the second end plate, wherein an outer end of the spring is movable in the first direction as the spring is wound around or released from the axis.

In an embodiment, the connection portion may have a variable length in the first direction.

In an embodiment, the connection portion may include a coupling structure of a bolt and a nut.

In an embodiment, the bolt and nut may have a shape extending in the first direction.

In an embodiment, the connection portion may include a plurality of the coupling structures, and the plurality of coupling structures may be arranged in an axial direction of the spring.

In an embodiment, the connection portion may further include a first linker connecting the outer end of the spring and the coupling structure.

In an embodiment, the connection portion may include a plurality of the coupling structures, and the plurality of coupling structures may be connected to the first linker.

In an embodiment, the connection portion may further include a second linker connecting the second end plate and the coupling structure.

In an embodiment, the second linker may have at least a portion thereof embedded in the second end plate.

In an embodiment, the connection portion may include a plurality of the coupling structures, and the plurality of coupling structures may be connected to the second linker.

In an embodiment, the pressurizing portion may further include a shaft connected to an inner end of the spring and extending in the axial direction of the spring, and a fixing bracket supporting the shaft.

In an embodiment, the pressurizing portion may be provided in plural.

In an embodiment, on a plane projected in the first direction, the plurality of pressurizing portions may be disposed symmetrically with respect to a center of the first end plate.

In an embodiment, the first end plate may include a groove having a portion of a side surface thereof cut out, and a portion of the connection portions may be disposed in the groove of the first end plate.

In an embodiment, the first end plate may include a through-hole formed in the first direction, and a portion of the connection portions may be disposed in the through-hole of the first end plate.

In an embodiment, the axial direction of the spring may be perpendicular to the first direction.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating the exterior of an electrochemical device according to an embodiment of the present disclosure;

FIG. 2 is an exploded view of some components of the electrochemical device of FIG. 1;

FIG. 3 is a plan view of a region of the electrochemical device of FIG. 1;

FIG. 4 is a cross-sectional view of a region of the electrochemical device, illustrating a state of the electrochemical device before heat treatment and pressurization;

FIG. 5 is a cross-sectional view of a region of an electrochemical device, illustrating a state of the electrochemical device before heat treatment and after pressurization;

FIG. 6 is a cross-sectional view of a region of an electrochemical device, illustrating a state of the electrochemical device after heat treatment;

FIG. 7 is an enlarged view of a stack region including an electrochemical cell in an electrochemical device;

FIG. 8 is a perspective view schematically illustrating the exterior of an electrochemical device according to a modified embodiment; and

FIG. 9 is a perspective view schematically illustrating the exterior of an electrochemical device according to a modified embodiment.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numerals are the same elements in the drawings.

In the drawings, irrelevant descriptions will be omitted to clearly describe the present disclosure, and to clearly illustrate a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

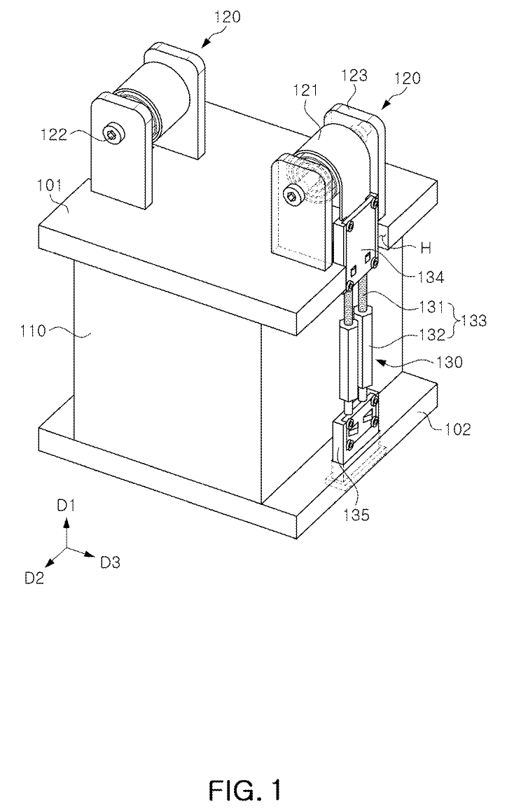

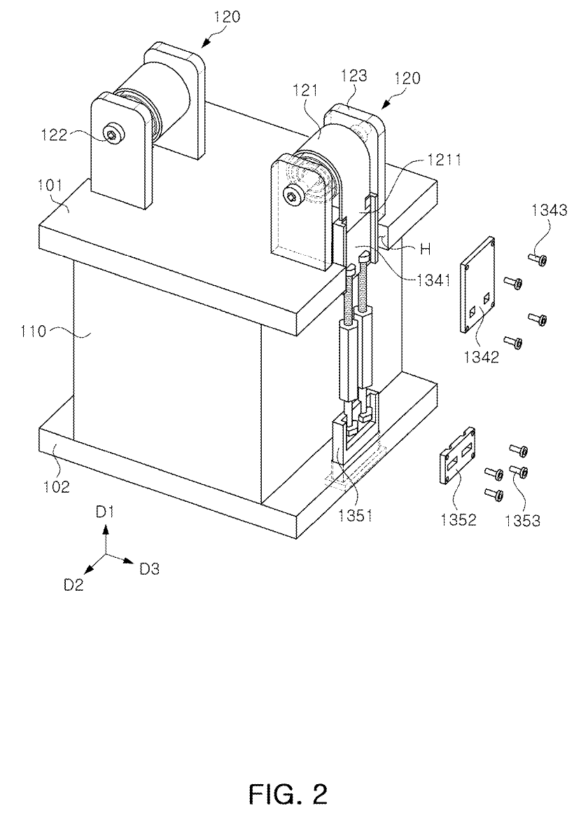

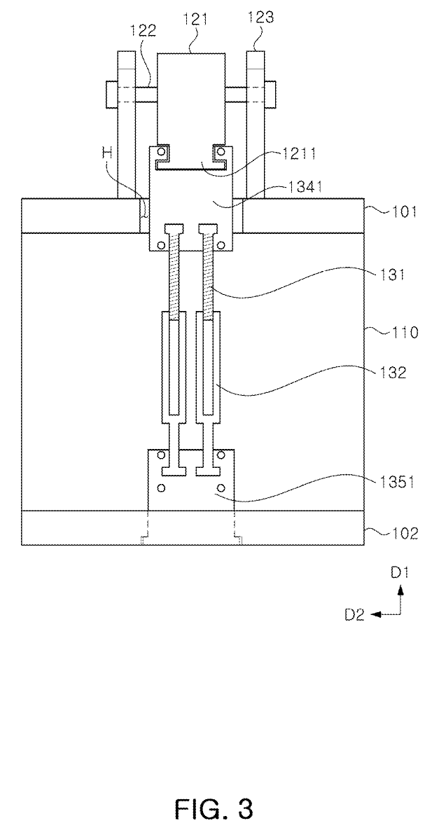

FIG. 1 is a perspective view schematically illustrating the exterior of an electrochemical device according to an embodiment of the present disclosure. FIG. 2 is an exploded view of some components of the electrochemical device of FIG. 1. FIG. 3 is a plan view of a region of the electrochemical device of FIG. 1.

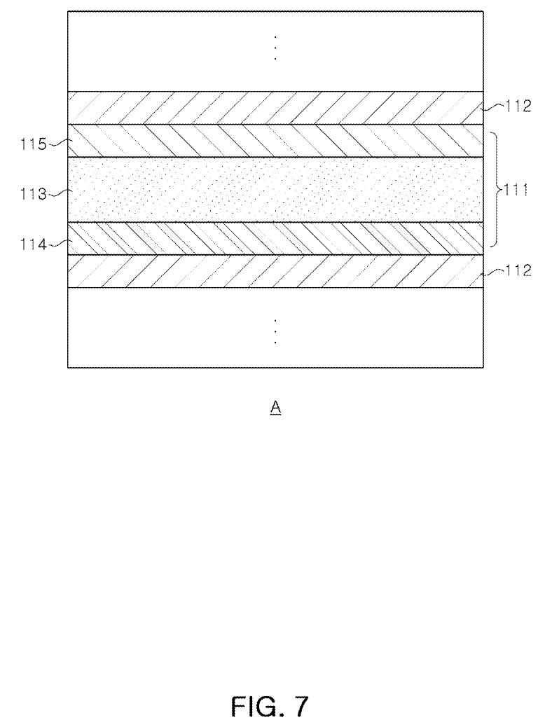

Referring to FIGS. 1-3, an electrochemical device 100 according to an embodiment of the present disclosure includes first and second end plates 101 and 102 stacked in a first direction D1, a stack region 110 including an electrochemical cell (111 of FIG. 7), a pressurizing portion 120, and a connection portion 130, wherein a spring 121 included in the pressurizing portion 120 is wound around an axis in a direction, different from the first direction D1, for example, a second direction D2. An outer end 1211 of the spring 121 may move in the first direction D1 as the spring 121 is wound around or released from an axis, and a load applied to the stack region 110 may be adjusted by the movement of the spring 121. According to the pressurizing method of the pressurizing portion 120 according to the present embodiment, a uniform load may be applied to the stack region 110 without being excessively affected by a change in temperature or a degree of winding of the spring 121, and accordingly, the current collection efficiency and durability of the electrochemical device 100 may be improved. Hereinafter, main components constituting the electrochemical device 100 will be described.

The first and second end plates 101 and 102 may be stacked in the first direction D1, and can protect the stack region 110, or the like. In this case, a load applied to the first and second end plates 101 and 102 by the pressurizing portion 120 may be transferred to the stack region 110, or the like. The first and second end plates 101 and 102 may include a metal with a high melting point to prevent melting or softening even when an electrochemical cell 111 included in the stack region 110 operates at high temperatures. The metal may have a flat-plate structure. For example, the first and second end plates 101 and 102 may be formed of nickel-based materials, iron-based materials, stainless-steel-based materials, or other materials. When an operating temperature of the electrochemical cell 111 is relatively low, for example, about 800ºC or lower, copper or a copper alloy with good electrical conductivity may also be used.

The stack region 110 is disposed between the first and second end plates 101 and 102, and includes at least one electrochemical cell 111. Referring to FIG. 7, the electrochemical cell 111 of the stack region 110 may be a water electrolysis cell, a fuel cell, or the like. The electrochemical cell 111 may be provided in plural and the plurality of electrochemical cells 111 may be stacked, and a separator 112 may be disposed between adjacent electrochemical cells 111. For example, a solid oxide cell may be used as the electrochemical cell 111. Specifically, the electrochemical cell 111 may include a fuel electrode 114, an air electrode 115, and an electrolyte 113 disposed therebetween. Here, the fuel electrode 114 may include a cermet layer including a metal phase and a ceramic phase. Here, the metal phase may include a metal catalyst, such as nickel (Ni), cobalt (Co), copper (Cu), or an alloy thereof, which acts as an electron conductor. The metal catalyst may be in a metallic state or an oxide state. In the case of the ceramic phase of the fuel electrode 114, the ceramic phase of the fuel electrode 114 may include gadolinia-doped ceria (GDC), samaria-doped ceria (SDC), ytterbia-doped ceria (YDC), scandia-stabilized zirconia (SSZ), ytterbia-ceria-scandia-stabilized zirconia (YbCSSZ), and the like. The air electrode 115 may include an electrically conductive material, such as an electrically conductive perovskite material such as lanthanum strontium manganite (LSM). Other conductive perovskites, such as lanthanum strontium cobalt (LSC), lanthanum strontium cobalt manganese (LSCM), lanthanum strontium cobalt ferrite (LSCF), lanthanum strontium ferrite (LSF), La_{0.85}Sr_{0.15}Cr_{0.9}Ni_{0.1}O₃ (LSCN), or a metal such as Pt may also be used. In some embodiments, the air electrode 115 may include a mixture of an electrically conductive material and an ionically conductive ceramic material. For example, the air electrode 115 may include about 10 wt% to about 90 wt% of an electrically conductive material (e.g., LSM, or the like) and about 10 wt% to about 90 wt% of an ionically conductive material. Here, the ionically conductive material may include a zirconia-based and/or ceria-based material. The electrolyte 113 may include stabilized zirconia. Specifically, the electrolyte 113 may include scandia-stabilized zirconia (SSZ), yttria-stabilized zirconia (YSZ), scandia-ceria-stabilized zirconia (SCSZ), scandia-ceria-yttria-stabilized zirconia (SCYSZ), scandia-ceria-ytterbia -stabilized zirconia (SCYbSZ), and the like.

Meanwhile, a case in which the electrochemical cell 111 is a solid oxide cell is described as above, but the electrochemical cell 111 may also be a polymer electrolyte membrane cell.

The separator 112 is a component separating the plurality of electrochemical cells 111 and may include a flow path to allow fluid to flow smoothly. In addition, the separator 112 may be formed of a conductive material. Specifically, the separator 112 may include a high-melting-point metal to prevent melting or softening at high temperatures when the electrochemical device 100 is used as an SOEC or SOFC. For example, the separator 112 may be formed of a nickel-based material, iron-based material, stainless-steel material, or the like. Meanwhile, a current collector formed of a conductive porous structure, or the like may be disposed between the electrochemical cell 111 and the separator 112.

Referring again to FIGS. 1-3, the pressurizing portion is disposed on the outside of the first end plate 101, and includes a spring 121 wound around an axis in a direction, different from the first direction D1. Here, in the present embodiment, the axis of the spring 121 extends parallel to a second direction D2 among the directions perpendicular to the first direction D1. However, a spring 121 having an axis in a different direction may also be provided, and for example, as in the embodiment described below, the pressurizing portion 120 may include a spring 121 extending in a third direction D3. In addition, the case in which an axial direction of the spring 121 is perpendicular to the first direction D1 does not necessarily mean a case in which the axial direction is perfectly perpendicular, but includes a case in which the axial direction is substantially perpendicular to the first direction D1. The connection portion 130 is connected to the spring 121 and the second end plate 102 and functions to pressurize the electrochemical device 100 together with the pressurizing portion 120. In this case, an outer end 1211 of the spring 121 may move in the first direction D1 as the spring 121 is wound around or released from the axis, so that a load applied to the stack region 110 may be adjusted.

There was a problem in that, as the conventional coil spring was compressed and stretched vertically, the load, i.e., a force transmitted by the spring to the outside, also changed significantly. In the present embodiment, the spring 121 included in the pressurizing portion 120 was designed so that the outer end 1211 may move in the first direction D1, and the load applied to the stack region 110 does not change significantly depending on the change in temperature or the degree of winding of the spring 121. In order to improve the current collection efficiency of the electrochemical device 100, it is preferable to operate the device while maintaining a constant level of pressure after heat treatment, and by applying a uniform load to the stack region 110 as in the present embodiment, not only the performance but also the durability of the electrochemical device 100 may be improved.

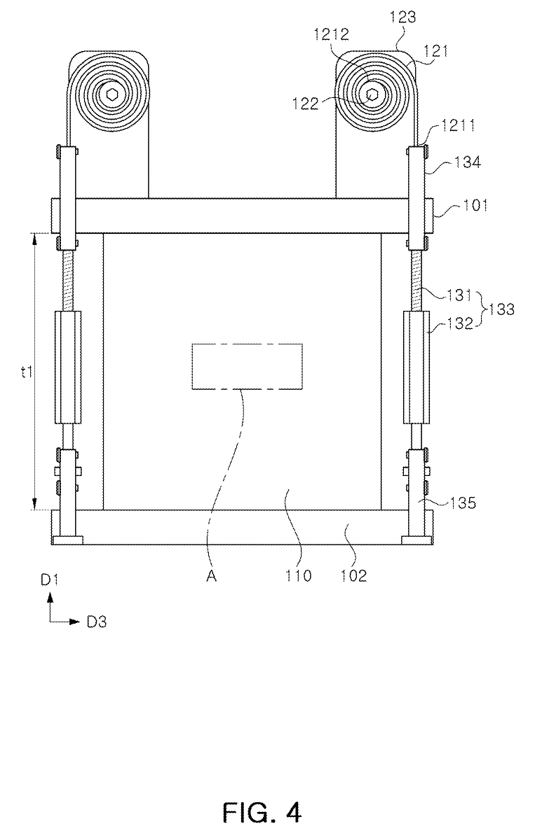

Looking specifically at the method in which the spring 121 is disposed in the pressurizing portion 120, first, the pressurizing portion 120 may further include a shaft 122 connected to an inner end (1212 of FIG. 4) of the spring 121 and extending in a direction, different from the first direction D1, for example, a second direction D2, and a fixing bracket 123 supporting the shaft 122. Here, the shaft 122 and the fixing bracket 123 may be implemented with a material including a heat-resistant alloy that does not melt or soften in an environment in which the electrochemical device 100 is operated. The spring 121 is a pressurizing means that can apply a uniform load regardless of displacement when wound or released, and may have a structure in which a flat strip material is wound around the shaft 122. In this case, the inner end 1212 of the spring 121 may be fixed to the shaft 122, and an outer end 1211 thereof may be connected to the connection portion 130 and may move. The spring 121 may be formed using a heat-resistant alloy, such as high-elasticity stainless steel, which does not show a large change in elastic coefficient or deformation even in a high-temperature environment. In addition, the connection portion 130 may have a variable length in the first direction D1 according to the movement of the spring 121, and may be implemented with a material including a heat-resistant alloy that does not melt or soften in the environment in which the electrochemical device 100 is operated.

As a structure in which the length of the first direction D1 can be varied, the connection portion 130 may include a coupling structure 133 of a bolt 131 and a nut 132. By employing the coupling structure 133 of the bolt 131 and the nut 132, the thickness of the stack region 110 may be effectively adjusted. In this case, the bolt 131 and the nut 132 may have a shape extending in the first direction D1, as illustrated in the drawing. The connection portion 130 may include a plurality of the coupling structures 133, and the plurality of coupling structures 133 may be arranged in an axial direction of the spring 121, for example, in the second direction D2. In addition, the connection portion 130 may further include a first linker 134 connecting the outer end 1211 of the spring 121 and the coupling structure 133. In this case, the plurality of coupling structures 133 may be connected to the first linker 134. Referring to FIG. 2, the first linker 134 may include a first base portion 1341 coupled to the spring 121 and a first cover portion 1342 covering the same, and a first fixing means 1343, such as a screw, for coupling the first base portion 1341 and the first cover portion 1342 may be provided. In addition, the connection portion 130 may further include a second linker 135 connecting the second end 102 and the coupling structure 133. As illustrated, at least a portion of the second linker 135 may be embedded in the second end plate 102. The plurality of coupling structures 133 may be connected to a second linker 135. The second linker 135 may include a second base portion 1351 coupled to the second end plate 102 and a second cover portion covering the same, and a second fixing means 1353 such as a screw, or the like, coupling the second base portion 1351 and the second cover portion 1352, may be provided.

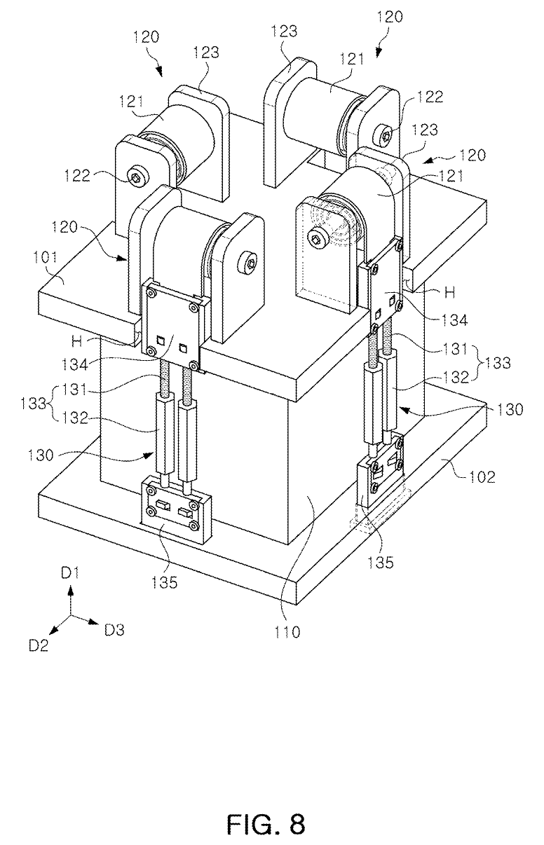

The pressurizing portion 120 may be disposed in a position in which a load may be efficiently and uniformly applied to the stack region 110. In this case, the pressurizing portion 120 may be provided in plural, and the plurality of pressurizing portions 120 may be disposed symmetrically with respect to a center of the first end plate 101 when projected in the first direction D1. In the embodiments of FIGS. 1-3, two pressurizing portions 120 are provided, and the pressurizing portions are in the form of a spring 121 wound around an axis extending in the second direction D2. The two pressurizing portions 120 are spaced apart in the third direction D3 and form a line-symmetrical structure with respect to an upper surface of the first end plate 101. Alternatively, as in a modified example of FIG. 8, the number of pressurizing portions 120 may be increased, with one pressurizing portion positioned at a corner of the first end plate 101. Specifically, four pressurizing portions 120 may be provided, and in the embodiment of FIGS. 1-3, two pressurizing portions 120 are added. For the two additional pressurizing portions 120, the spring 121 is wound around an axis extending in the third direction D3 and is spaced apart in the second direction D2 to form a line-symmetrical structure. The four pressurizing portions 120 may be symmetrical with respect to the center of the first end plate 101 when projected in the first direction D1.

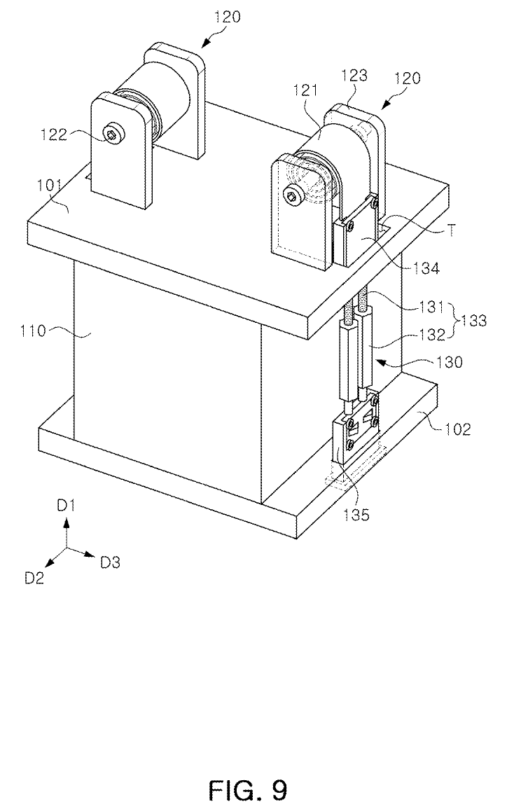

Referring again to FIGS. 1-3, positions in which the pressurizing portion 120 and the connection portion 130 are disposed may be appropriately selected, and for example, may be disposed in a region thereof, adjacent to a corner of the electrochemical device 100. In addition, the first end plate 101 includes a groove H in which a portion of a side surface thereof is cut off, and a portion of the connection portions 130 may be disposed in the groove H of the first end plate 101. As a modified example therefrom, as illustrated in FIG. 9, the first end plate 101 may include a through-hole (T) formed in the first direction D1, and a portion of the connection portions 130 may be disposed in the through-hole (T) of the first end plate 101.

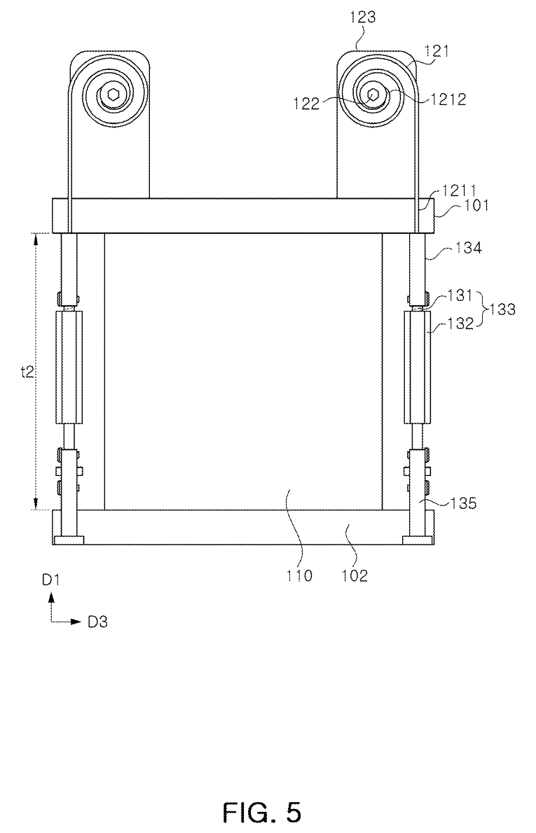

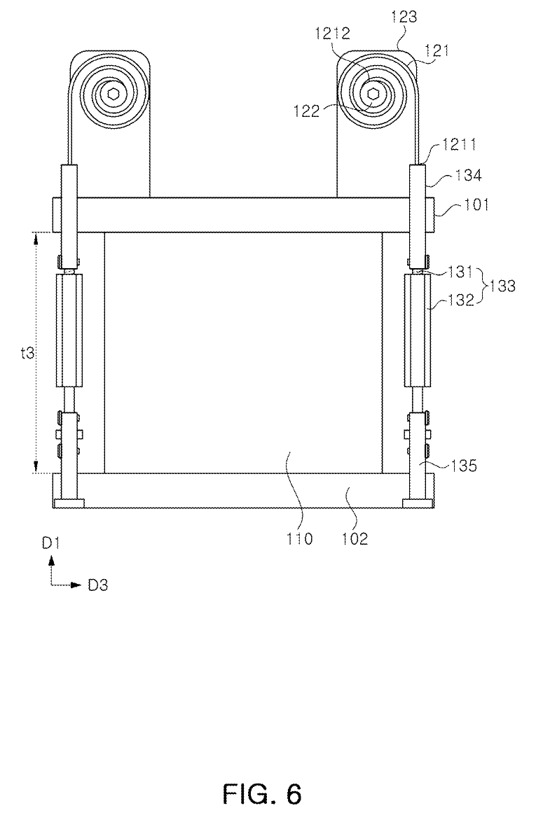

Referring to FIGS. 4-6, the operations of the pressurizing portion 120 and the connection portion 130 during the heat treatment and driving process of the electrochemical device 100 will be described. First, FIG. 4 is a cross-sectional view of a region of the electrochemical device 100, illustrating the state before heat treatment and pressurization. Before heat treatment and pressurization, a thickness of the stack region 110 is t1, and since the spring 121 is wound, an upper end of the connection portion 130 is positioned relatively thereabove. Thereafter, as illustrated in FIG. 5, the stack region 110 is pressurized before heat treatment of the electrochemical device 100. In this case, a thickness (t2) of the stack region 110 may be substantially the same as a thickness (t1) thereof before pressurization. To pressurize the stack region 110, a bolt 131 may be fastened to a nut 132, thereby reducing a length of the connection portion 130. The length of the connection portion 130 may be adjusted by adjusting a fastening amount of the bolt 131 and the nut 132. FIG. 6 illustrates the state after heat treatment. In the case of an electrochemical device 100 such as a solid oxide cell stack, a heat treatment process is performed for hermetic sealing. During the heat treatment, shrinkage of the stack region 110 occurs, resulting in a decrease in a thickness (t3) of the stack region 110. In a pressurized structure using a coil spring as in the prior art, the coil spring should be installed after heat treatment to enable constant pressure operation. However, in the process of mounting the coil spring at room temperature, the durability of electrochemical cells, which are vulnerable to thermal shock, may be reduced. A pressurizing portion 120 including a spring 121 as in the present embodiment may be mounted before heat treatment of the electrochemical device 100 to apply a load to the stack region 110, and since the change in the load applied to the stack region 110 is not large even after heat treatment, it can contribute to improving the current collection efficiency and durability of the electrochemical device 100.

As set forth above, in the case of an electrochemical device according to an example of the present disclosure, the electrochemical device may have a pressurizing portion for applying a stable pressurizing force to a stack structure of an electrochemical cell, and accordingly, thermal shock acting on the electrochemical cell may be alleviated, so that the performance and durability may be improved.

While example embodiments have been shown and described above, it will be apparent to those skilled in the art that modifications and variations could be made without departing from the scope of the present invention as defined by the appended claims.

What is claimed is:

1. An electrochemical device, comprising:
first and second end plates stacked in a first direction;
a stack region disposed between the first and second end plates, the stack region including at least one electrochemical cell;
a pressurizing portion disposed on an outside of the first end plate, and including a spring wound around an axis in a direction, different from the first direction; and
a connection portion connected to the spring and the second end plate,
wherein an outer end of the spring is movable in the first direction as the spring is wound around or released from the axis.

2. The electrochemical device of claim 1, wherein the connection portion has a variable length in the first direction.

3. The electrochemical device of claim 1, wherein the connection portion includes a coupling structure of a bolt and a nut.

4. The electrochemical device of claim 3, wherein the bolt and the nut have a shape extending in the first direction.

5. The electrochemical device of claim 3, wherein the connection portion includes a plurality of the coupling structures, and
the plurality of coupling structures are arranged in an axial direction of the spring.

6. The electrochemical device of claim 3, wherein the connection portion further includes a first linker connecting the outer end of the spring to the coupling structure.

7. The electrochemical device of claim 6, wherein the connection portion includes a plurality of the coupling structures, and
the plurality of coupling structures are connected to the first linker.

8. The electrochemical device of claim 3, wherein the connection portion further includes a second linker connecting the second end plate to the coupling structure.

9. The electrochemical device of claim 8, wherein the second linker has at least a portion thereof embedded therein.

10. The electrochemical device of claim 8, wherein the connection portion includes a plurality of the coupling structures, and
the plurality of coupling structures are connected to the second linker.

11. The electrochemical device of claim 1, wherein the pressurizing portion further includes a shaft connected to an inner end of the spring and extending in an axial direction of the spring, and a fixing bracket supporting the shaft.

12. The electrochemical device of claim 1, wherein the pressurizing portion is provided in plural.

13. The electrochemical device of claim 12, wherein on a plane projected in the first direction, a plurality of pressurizing portions are disposed symmetrically with respect to a center of the first end plate.

14. The electrochemical device of claim 1, wherein the first end plate includes a groove in which a portion of a side surface thereof is cut out, and a portion of the connection portion is disposed in the groove of the first end plate.

15. The electrochemical device of claim 1, wherein the first end plate includes a through-hole formed in the first direction, and a portion of the connection portion is disposed in the through-hole of the first end plate.

16. The electrochemical device of claim 1, wherein an axial direction of the spring is perpendicular to the first direction.
